(19) United States
(12) Patent Application Publication
(10) Pub. No.: US 2025/0283725 A1
(43) Pub. Date: Sep. 11, 2025

(54) CLASSICAL-QUANTUM HYBRID APPROACH TO MULTI-HOP ROUTING IN CARGO LOGISTICS

(71) Applicant: Unisys Corporation, Blue Bell, PA (US)

(72) Inventors: Bhavika BHALGAMIYA, Starkville, MS (US); Dastgeer SHAIKH, Plainsboro Township, NJ (US)

(21) Appl. No.: 18/601,580

(22) Filed: Mar. 11, 2024

(51) Int. Cl. G01C 21/34; G06Q 10/047

(52) U.S. Cl. CPC G01C 21/3453; G06Q 10/047

(57) ABSTRACT

An optimal route can be determined for delivering an item through a logistics system where vehicles have multiple stops when traveling along routes. The optimal route is determined using a hybrid system employing a classical computing device and a quantum annealer. The classical device reduces the search space that allows the quantum annealer to determine a more optimal solution. In an aspect, a routing graph comprising nodes and edges is populated from routes of vehicles, where the nodes identify locations and the edges represent routing data. At least a portion of the nodes and edges is removed to form a refined routing graph. For an origin-destination input, the refined routing graph can be filtered according to a first set of routing constraints to form a reduced route search space. A quantum annealer is invoked according to an objective and a different second set of routing constraints.

### BACKGROUND

Logistics route optimization is a process in supply chain management, aiming to enhance efficiency by determining the most effective routes for transporting objects between various nodes. This process encompasses a multitude of variables and necessitates sophisticated algorithms to solve. A classic, well-studied problem in this domain is the Traveling Salesman Problem (TSP), which asks for the shortest possible route that visits each city exactly once and returns to the origin city. The TSP, though simple to state, is a computationally challenging problem, and its solutions have broad applications in logistics, aiding in the design of effective delivery and transportation systems, and the programs that govern these systems.

The multi-hop routing problem in logistics refers to a complex scenario where goods need to be transported from their origin to their final destination through multiple intermediate stops or “hops.” Unlike direct or single-hop routing, where goods are transported directly from the source to the destination, multi-hop routing involves several legs of the journey, often using different modes of transportation or going through various intermediate locations.

### SUMMARY

The technology generally relates to methods employing a hybrid system to improve the quantum annealing process for determining optimal routes through multi-hop routing environments. For instance, the hybrid methods use a classical computing system to reduce the search space by applying a first set of routing constraints, thus allowing the quantum annealer to explore a reduced route search space. This enables the quantum annealer to explore a search space that may otherwise go unexplored due to the constraint density threshold of the quantum annealer.

One example method generates a routing graph that comprises nodes and edges populated from routes of vehicles. The nodes identify locations through which the vehicles travel along the routes, while the edges identify routing data for route segments between nodes through which the vehicles travel when traversing the routes.

From the routing graph, nodes and edges for which arrival times exceed departure times are removed for nodes connecting at least two route segments. This helps remove nodes and edges where vehicles arrive after connecting vehicles have already departed. The removal of the nodes and edges forms a refined routing graph. The refined routing graph can be used for determining optimal routes between nodes within the refined routing graph.

When an origin-destination input that identifies a destination node and an origin node is received, nodes and edges can be filtered from the refined routing graph according to a first set of routing constraints. This filtering forms a reduced route search space having routes through the remaining nodes, where the routes begin at the origin node and end at the destination node.

A quantum annealer can be invoked to generate an optimal route from the reduced route search space according to an objective and a second set of routing constraints. The second set of routing constraints may include constraints that are different from the first set of constraints. In doing so, the number of constraints applied by the quantum annealer to determine the optimal route is reduced. By using the first set of routing constraints as a filter by a classical computing system, the now reduced route search space can be more deeply explored by a quantum annealer.

This Summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an operating environment in which aspects of the technology may be implemented, in accordance with an aspect described herein;

FIG. 2 illustrates an example routing graph, in accordance with an aspect described herein;

FIG. 3 illustrates an example refined routing graph, in accordance with an aspect described herein;

FIG. 4 illustrates an example filtering of the refined routing graph to form a reduced route search space, in accordance with an aspect described herein;

FIG. 5 illustrates a method 500 in accordance with one embodiment;

FIG. 6 illustrates an example quantum annealer suitable for use with the present technology, in accordance with an aspect described herein;

FIG. 7 illustrates an example quantum annealing process that may be performed by the quantum annealer of FIG. 6 to determine an optimal routing solution, in accordance with an aspect described herein; and

FIG. 8 illustrates an example computing device suitable for implementing aspects of the present technology, in accordance with an aspect described herein.

### DETAILED DESCRIPTION

Logistic optimization of routes is a complex problem. It may be described as a combinatorial optimization problem with N-polynomial hard complexity and can have a large solution domain that is computationally intensive to access on a given modern-day computer, including the use of cloud computing resources and high performance computing (HPC).

These logistics problems arise in a multitude of areas where objects can be moved within various locations along different defined routes, including transportation of cargo, such as freight or people, using ground routes, air routes, sea routes, and combinations thereof; movement of objects about a facility, such as along conveyor systems or other transport systems; routing of aircraft, ground vessels, or sea vessels about various destinations; or other like routing processes moving object(s) to locations in which there are multiple travel paths through multiple nodes.

The complexity of the decision making when determining optimal routes exponentially increases with the number of routes, constraints, objective functions, and many other parameters that play pivotal roles in obtaining a meaningful solution. Traditionally, attempted solutions to these problems by quantum computing techniques relied on quadratic and binary optimizations. Even with these approaches, not all solutions can be determined, and even good solutions may not be determined in a realistic time with desirable accuracy.

In the context of quantum annealing, quantum annealers are generally limited by what can be considered a constraint density threshold. Constraint density refers to the complexity of the optimization problem in terms of the constraints and variables considered when solving the problem. The constraint density threshold involves considering the interplay between the annealer's hardware design and the nature of the optimization problem. This threshold reflects the maximum complexity level of a problem that the quantum annealer can handle effectively. More broadly, this refers to the operational limitation of the quantum annealer.

Central to the quantum annealer's capability is the number of qubits in the quantum annealer. The qubits are the core elements that represent the problem's variables, and their quantity and connectivity directly influence the size of the problem that can be addressed. The connectivity among qubits, dictated by the annealer's architecture, affects the problem mapping. This involves mapping the problem's variables and constraints onto the qubits and their interactions. Thus, as the complexity of a problem increases, the challenge of effectively embedding it into the annealer's structure also rises. If the problem's constraint density exceeds the annealer's capacity, efficient embedding could become impossible, leading to no solution or a sub-optimal solution.

The size of the search space, dictated by the constraint density, also plays a role. A higher constraint density typically means a larger and more complex search space, which can be challenging for the quantum annealer to explore effectively, given its finite number of qubits and limited connectivity. Put another way, because of the physical limitations of the qubits and their connectivity, precision of the solution found by a quantum annealer can be inversely related to the complexity of the problem. For simpler problems (low constraint density), the annealer can often find more precise solutions. For more complex problems (high constraint density), the precision may decrease, as the annealer may not be able to fully explore the vast search space, might become trapped in local minima, or experience negative complex qubit fluctuation. For problems that are even more complex, their constraint density could exceed the constraint density threshold of the quantum annealer, and thus, the problem may not be solvable at all.

The technology provided herein provides for a hybrid approach that uses both a classical computing device and quantum annealing to determine the most optimal route through locations by vehicles that travel across multiple route segments when traversing a route. A process employed by the classical computing device to reduce the route search space enhances the quantum annealer's ability to solve for a more optimal route solution to the problem that it otherwise would be able to given its limitations.

Reducing a problem's constraint density using classical computation before solving it with a quantum computer can significantly improve the quantum computer's ability to handle the problem, particularly due to hardware limitations of the quantum system. As noted, the effectiveness in solving a problem is largely dependent on how well the problem can be mapped onto the quantum hardware, which includes the number of qubits and their interconnectivity.

By using classical computers to reduce the search space, e.g., the constraint density, the complexity of the problem is lowered. A simpler problem with fewer constraints and variables is easier to map onto the quantum hardware. The quantum annealer can explore the search space more effectively. This is because simpler problems allow for a more thorough exploration within the hardware's limitations, thereby increasing the likelihood of finding optimal or near-optimal solutions.

In aspects of technology, a first set of constraints can be applied using the classical device, effectively reducing the number of constraints of the optimization problem solved by the quantum annealer, allowing for more variables to be processed by the annealer and a deeper solution space explored. In essence, the quantum annealer can effectively tackle more complex problems than it could without the initial use of the classical device. This synergy between classical and quantum expands the capabilities of quantum annealers, limited by their hardware and design. This reduction in complexity means that the quantum annealer, with its fixed number of qubits and specific qubit connectivity, can map and solve the problem more efficiently. In some complex cases, without the initial application of the classical device, the quantum annealer might be unable to handle the original problem complexity due to limitations such as insufficient qubit connectivity or the sheer number of variables and constraints, which can drive solutions to unstable and local minima regions.

The combined use of the classical device and the quantum annealer allows the quantum annealer to focus on a more tractable problem space. This not only improves the quality of solutions but also enables the quantum annealer to address a broader range of problems, including previously unsolvable problems that result from their inherent complexity. The reduced complexity leads to a more efficient exploration of the search space within the hardware's constraints, thereby enhancing the overall problem-solving capabilities of the quantum annealer.

One example method that achieves these benefits to determine an optimal route in which vehicles can have multiple stops at different locations generates a routing graph comprising nodes and edges. When generating the routing graph, the nodes and edges are populated from routes taken by vehicles. In the context of this description, the term “node” is intended to represent a location. In some cases, vehicles travel directly from one node to the next, i.e., from one location directly to another, while in other cases, vehicles travel to a final node through one or more intervening nodes, i.e., stopping at one more locations before arriving at a final location. A vehicle is generally any system that can transport an item from one location to another. A vehicle may be a system that predominantly traverses land, air, or sea. Vehicles may be manned or unmanned systems.

While the nodes represent locations, the edges connect the nodes and represent routing data for route segments for vehicles traveling between nodes. Thus, for instance, a route may have one or more route segments, as route segments can be connected to form routes through the nodes. Routing data may include information such as arrival times, departure times, route segment duration, and so forth.

Having generated the routing graph of nodes and edges, a portion of the nodes and edges can be removed to form a refined routing graph. This step helps reduce the size of the search space. The nodes and edges at this stage can be removed where arrival times exceed departure times for a node connecting at least two route segments.

The refined routing graph may be used to determine on optimal route from a destination node and an origin node for a given origin-destination input. To do so, nodes and edges can be filtered according to a first set of routing constraints, such as filtering out nodes and edges for routes exceeding a specific time, such as through a delivery time for delivering an item to the destination node. Other constraints within the first set of routing constraints may include a weight or volume, filtering out nodes and edges for vehicles where an item being delivered by the vehicle would exceed a weight or volume capacity of the vehicle. By filtering the refined routing graph according to the first set of routing constraints, a reduced route search space is generated, which includes the remaining nodes and edges having routes that extend between the origin node and destination node.

A classical computing device can be used to generate the reduced route search space by generating the routing graph and the refined routing graph, and filtering the refined routing graph for a given origin-destination input consistent with an original request for a solution. The reduced route search space having the remaining nodes and edges can be provided to a quantum annealer and can be annealed based on an objective and a second set of routing constraints. For instance, the objective to minimize the duration of travel by one or more vehicles between the origin and the destination may be constrained to beginning at the origin and terminating at the destination, along with having a route formed by only connected route segments. In doing so, the quantum annealer determines the optimal route from the reduced route search space.

It will be realized that the method previously described is only an example that can be practiced from the description that follows, and it is provided to more easily understand the technology and recognize its benefits. Additional examples are now described with reference to the figures.

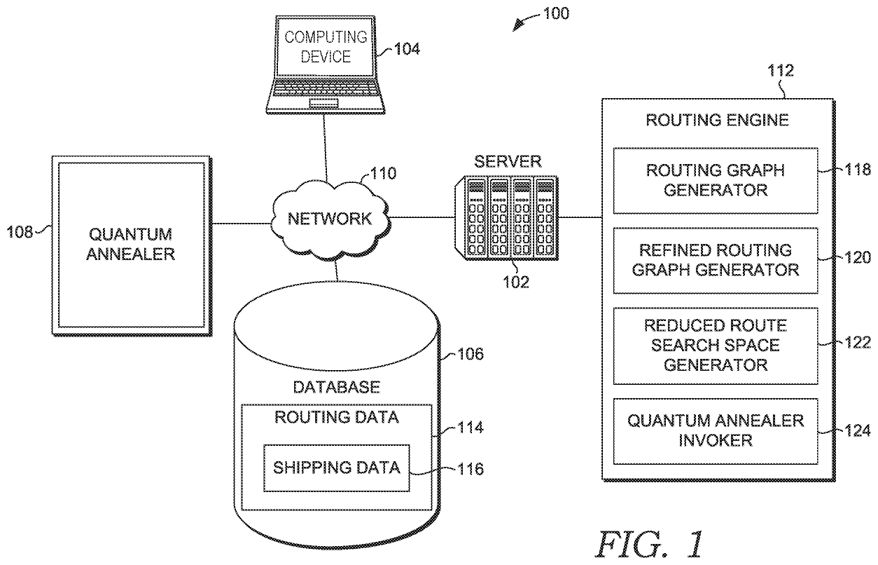

With reference now to FIG. 1, an example operating environment 100 in which aspects of the technology may be employed is provided. Among other components or engines not shown, operating environment 100 comprises server 102, computing device 104, database 106, and quantum annealer 108, which are communicating via network 110.

Database 106 generally stores information, including data, computer instructions (e.g., software program instructions, routines, or services), or models used in embodiments of the described technologies. Although depicted as a single database component, database 106 may be embodied as one or more databases or may be in the cloud. In aspects, database 106 is representative of a distributed ledger network.

Network 110 may include one or more networks (e.g., public network or virtual private network [VPN]), as shown with network 110. Network 110 may include, without limitation, one or more local area networks (LANs), wide area networks (WANs), or any other communication network or method.

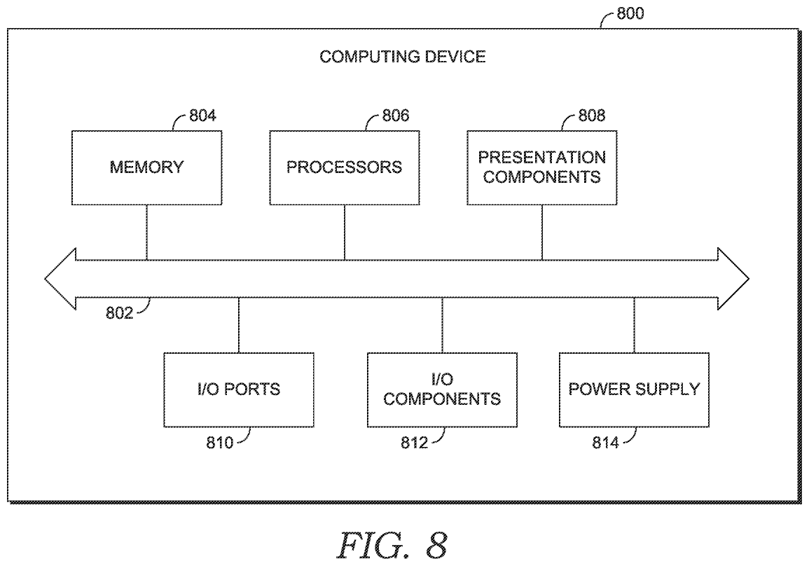

Generally, server 102 is a computing device that implements functional aspects of operating environment 100, such as one or more functions of routing engine 112 to facilitate determination of an optimal solution to a logistics optimization problem, such as determining an optimal route for objects traveling through a plurality of nodes. One suitable example of a computing device that can be employed as server 102 is described as computing device 800 with respect to FIG. 8. In implementations, server 102 represents a back-end or server-side device.

Computing device 104 generally interfaces with server 102. As with other components of FIG. 1, computing device 104 is intended to represent one or more computing devices. One suitable example of a computing device that can be employed as computing device 104 is described as computing device 800 with respect to FIG. 8. In implementations, computing device 104 is a client-side or front-end device.

While the example architecture illustrated in FIG. 1 illustrates functions of routing engine 112 being performed by server 102, it will be understood that this is just one example, and there may be more or fewer functions of routing engine 112, which may be employed in various orders. It is further noted that, in some implementations of the technology, functions of routing engine 112 may be performed by other components of FIG. 1, including components not shown. As an example, in some implementations, computing device 104 may be used to perform functions of routing engine 112 in lieu of or in combination with server 102. The illustrated drawing is but one example used to aid in describing an aspect of the technology.

Quantum annealer 108 generally comprises an analog quantum computing device, such as those suitable for performing quantum annealing. As will be further described, quantum annealer 108 may receive instructions from other components of FIG. 1 for solving a quantum problem, such as an optimization problem. Quantum annealer 108 may be configured to receive a quantum problem and find an optimal solution to the problem through an annealing process, such as quantum annealing process 700. Quantum annealer 600 represents an example quantum annealer 600 that may be suitable as quantum annealer 108.

To determine a solution to an optimization problem, server 102 may employ routing engine 112. In the example illustrated, routing engine 112 of FIG. 1 comprises routing graph generator 118, refined routing graph generator 120, reduced route search space generator 122, and quantum annealer invoker 124. In aspects, a classical computing device, such as server 102, may be used to implement functions of routing engine 112.

Generally, routing graph generator 118 generates a routing graph. A routing graph comprises nodes and edges. The nodes represent locations through which vehicles may travel, including where vehicles are used to transport items. An item may be any living or non-living cargo transported by the vehicle, such as freight, people, and the like. In aspects, the vehicles may travel through more than one location, sometimes referred to as multi-hop or multi-stop. This often occurs in the airline industry, where aircraft travel between various airports either to return to the original airport or end at an entirely different airport. This multi-hop scenario may also occur with land or sea vehicles as well. At each stop, a vehicle may pick up, offload, and retain items that it is carrying onto the next location.

The nodes are connected by the edges. In aspects, the edges are representative of routing data 114. The routing data 114 may include information about the vehicle or route. As noted, routes may include one or more route segments, with each route segment extending between two nodes. In an aspect, edges provide a numerical representation of routing data specific to a particular route segment between two nodes. Thus, each edge may be compared relative to other edges. In terms of the routing graph, a length of the edges may correspond to the numerical representation of the edges, and as such, each edge in the routing graph has a length that is relative to the other edges. Each edge may represent one constraint coefficient of the routing data 114, such as travel duration, volume capacity, weight capacity, and so forth, or it may be a single value representation of the combined constrain coefficients according to a weighted scheme.

Routing data 114 can include data related to individual route segments and routes having a combination of route segments (i.e., multi-hop routes). For instance, routing data 114 may include starting locations, ending locations, total traversal time, departure time, arrival time, layover times, route distance, vehicle type, vehicle restrictions, volume capacity, weight capacity, and so forth for each route segment. In aspects, the routing data represents a value for each variable between the nodes, such as a different value for distance, duration, etc. In aspects, the routing data can represent a combined value, where each of the variables is weighted. In aspects, there may be multiple edges connecting two nodes, where each edge may represent a different route segment by a different vehicle between the nodes. In aspects, the vehicles have offset departure and arrival times between the nodes. The routing graph may be illustrated graphically or may be represented in tabular format, such as through relational data tables.

Routing data 114 can be determined from the routes taken by vehicles. A route generally includes at least two locations, including a departure location and a destination location. A route may include any number of locations. A route segment is all of or a portion of a route that extends between two nodes, also referred to as connected nodes. Thus, for example, an aircraft may depart from a first location, also referred to as an origin location, and land at a second location, also referred to as a destination location. The aircraft may continue to a third location. In doing so, the second location becomes a origin location and the third location becomes a destination location, and so forth. For a land vehicle, a vehicle may start at a first location and traverse along a route terminating at a second location. Here, the first location is referred to as the origin location, and the second as the destination location. Intermediary locations may be considered origin and destination locations as the vehicle continues along the route from the first location to the second location. In general, items being carried by the vehicles may continue on the vehicle through one or more nodes, may be transitioned to another vehicle to continue to another node, or may be offloaded.

In aspects, routing data 114 comprises shipping data 116, which generally relates to items being transported along route segments by vehicles. For instance, this may include item dimensions, e.g., height, width, and length; volume; item weight; item requirements, such as handling requirements, orientation requirements, crush or stack restrictions, and restrictions on transit with certain goods or in certain containers, or another restriction type; cost to transport an item; or other like data. Using routing data 114 and shipping data 116, the volume and weight of items being shipped by a vehicle can be determined for each route segment. This can be compared to the volume and weight capacity of the respective vehicles to determine whether an item will exceed the volume or weight capacity for a vehicle traversing through a route segment.

Thus, routing graph generator 118 populates the routing graph with the nodes and edges as determined from vehicles routes. This can include route segments that vehicles will traverse in the future. To provide an example, imagine that thousands of aircraft are traveling between various locations, or nodes. Each time an aircraft leaves one location and arrives at the next, the aircraft has traveled along a route segment between the two locations. This can be represented as two nodes connected by an edge, the nodes representing the locations and the edge representing routing data for the aircraft, e.g., the time of departure, the time of arrival, the duration of the travel, the aircraft volume capacity, the aircraft weight capacity, and so forth. These may be constraints that do not change during transit. Given that there are possibly thousands of route segments traveled by the various aircraft, there are many more routes extending from one given location to the other, as many different route segment combinations may be connected to generate the routes. When generating the routing graph from the route, the routing graph generated includes the thousands of nodes and edges generated from the various route segments.

To provide an example, routing graph generator 118 may generate the routing graph based on the following:

$$ℝ = MIN {\sum }_{i , j}^{n} {R}_{ji} {F}_{ij} ( c , d , w , v , p )$$

$$ℝ = ℝ \{ ( c , d , w , v , p , … ) \}$$

$$ℝ = routes$$

$$c = cost$$

$$d = duration$$

$$w = weight$$

$$v = volume$$

$$p = item or other parameters$$

$$i , j = origin and destination$$

Here, nodes and edges are generated from a given set of multiple routes. For example, if there is a route from A to C via B, then three nodes are generated: A, B and C, and two edges: edge A-B and edge B-C. The first formula above for generating the graph defines an objective function with some example optimization parameters-c, d, w, v, and p.

For the connected routing graph having n>1 nodes, the following solution may be applied:

$${\sum }_{k = 0}^{n} ρ ( {ϑ}_{k} ) \geq \frac{1}{2} ( n - 1 ) ,$$

where k is an integer, ρ is a connection, vₖ is the graph function for connectivity. In aspects, n is not negative.

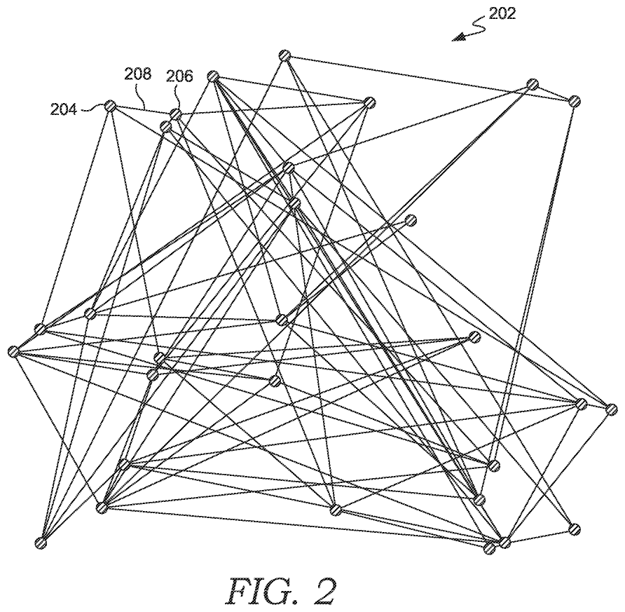

FIG. 2 illustrates an example routing graph 202 formed by routing graph generator 118. The illustrated example routing graph 202 includes nodes and edges. This is just one example, and other routing graphs may have more or fewer nodes and edges. In the illustration, node 204 and node 206 have been labeled as example nodes. These are connected nodes, either directly or indirectly, meaning that there is a vehicle that traverses between the nodes, forming a route segment between the nodes. The route segment may form the entire route between node 204 and node 206 or may be connected with other route segments to form a portion of a route between other notes. Edge 208 represents the routing data for the route segment between node 204 and node 206. Edge 208 may represent the cost, duration, weight, volume, or other constraint coefficient, or a combination thereof, for transporting an item between node 204 and node 206.

Having generated a routing graph, refined routing graph generator 120 may be used to generate a refined routing graph. In general, the refined routing graph may be generated by removing nodes and edges from the routing graph. This limits the number of routes that can be formed through the combination of nodes and edges remaining in the refined. For instance, route segments that do not feasibly connect to other route segments may be removed to form the refined routing graph.

One example method to remove at least a portion of the nodes and edges includes nodes and edges based on arrival times and departure times. That is, where vehicles are scheduled to arrive at a location after a departure time of another vehicle departing from the location along a connecting route segment. As such, nodes and edges can be removed from the routing graph for which arrival times exceed departure times for a node connecting at least two route segments, thereby forming a refined routing graph.

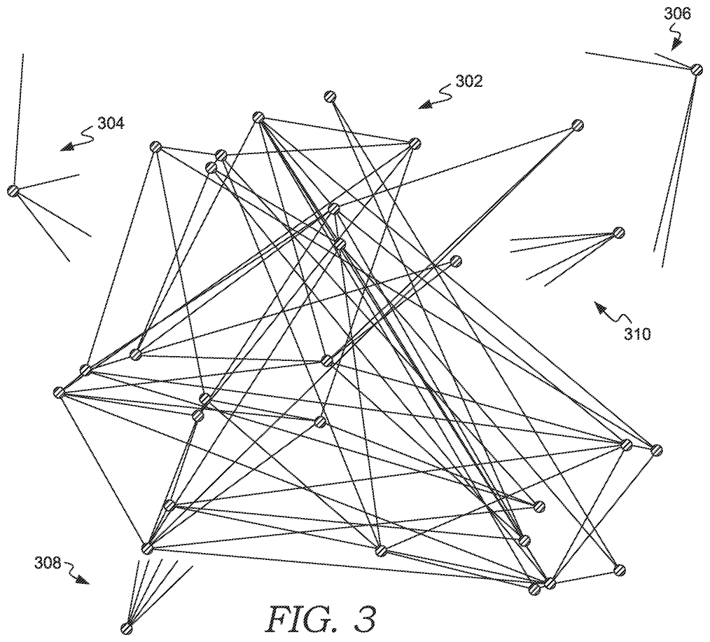

FIG. 3 illustrates an example of a refined routing graph 302. In this example, at least a portion of routes and route segments have been removed from routing graph 202 to form refined routing graph 302. As an illustrative example, removed node and edges 304, removed node and edges 306, removed node and edges 308, and removed node and edges 310 are shown as removed to form refined routing graph 302, which includes the nodes and edges remaining after the removal. In aspects, the refined routing graph 302 may serve as a model for which to determine optimal routes from a node within refined routing graph 302 to another node within refined routing graph 302.

When an origin-destination input that identifies an origin node and a destination node for an item is received, the refined routing graph may be used to determine the optimal route between the nodes. In an aspect, reduced route search space generator 122 may be employed by a classical device or algorithm to generate a reduced route search space from which quantum annealer 108 can be used to determine an optimal route from the origin node to the destination node.

In general, reduced route search space generator 122 generates a reduced route search space from the refined routing graph generated by refined routing graph generator 120. Reduced route search space generator 122 may be employed to filter at least a portion of the nodes and edges from the refined routing graph to generate the reduced route search space. The filtering may be performed based on an origin node and a destination node, such as that identified from the origin-destination input. For instance, the filtering by reduced route search space generator 122 may be done to remove nodes and edges that do not connect between the origin node and the destination node. In aspects, these nodes and edges may be identified where they are included in routes that exclude one or more of the origin node and the destination node.

In an aspect, reduced route search space generator 122 filters the refined routing graph using a first set of routing constraints. The first set of routing constraints may comprise one or more constraints, such as item delivery time, item weight, item volume, or the like. For instance, there may be millions of routes connecting 100 nodes. These can include single segment or multi-segment routes. For an item to be moved from node #2 (the origin) to node #6 (the destination), routes can be filtered having based on vehicle departure time from node #2 and arrival time at node #6. For instance, a defined delivery time may be used to filter the nodes and edges for routes segments that would arrive beyond the delivery time. Other parameters such as weight and volume capacity of the vehicle may also be considered.

For example, the first set of routing constraints may comprise an item delivery time constraint. As noted, items may be transported by vehicles. The origin-destination input may comprise an item delivery time for which an item is to be delivered to a delivery destination, e.g., the destination node of the origin-destination input. The first set of routing constraints may include the associated item delivery time. Thus, routes arriving at the destination node beyond the item delivery time may be filtered from the refined routing graph to form the reduced route search space.

In an aspect, the first set of routing constraints comprises a weight constraint for the item. As noted, vehicles traveling along routes and route segments may have vehicle weight capacities. Where the addition of the item being delivered to the destination node exceeds the vehicle weight capacity for a vehicle along a route segment of the route, such routes or route segments may be filtered from the refined routing graph to form the reduced route search space.

In an aspect, the first set of routing constraints comprises a volume constraint for the item. As noted, vehicles traveling along routes and route segments may also have vehicle volume capacities. Where the addition of the item being delivered to the destination node exceeds the vehicle volume capacity for a vehicle along a route segment of the route, such routes or route segments may be filtered from the refined routing graph to form the reduced route search space.

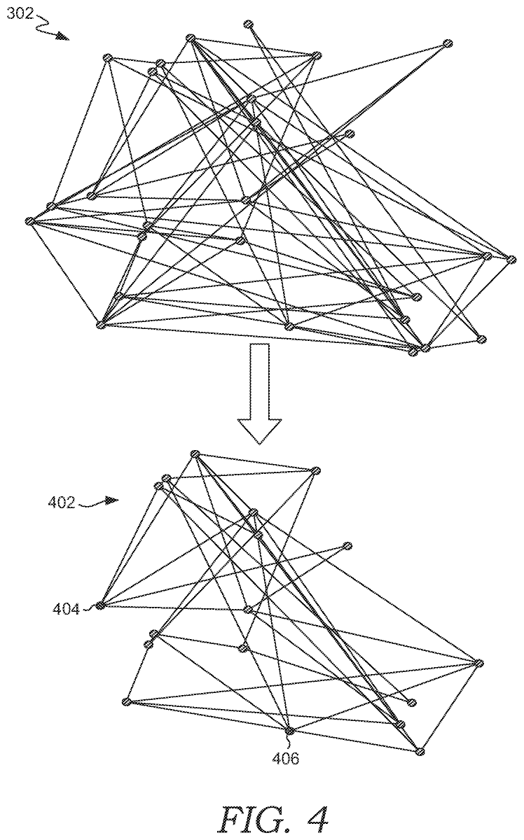

FIG. 4 illustrates reduced route search space generator 122 filtering refined routing graph 302. As noted, reduced route search space generator 122 may filter refined routing graph 302 according to one or more constraints of a first set of routing constraints. As illustrated during the filtering, some of the route segments, including nodes associated therewith, are filtered from refined routing graph 302 to form reduced route search space 402 for a particular origin node 404 and destination node 406, as determined from an origin-destination input, for example. It should be noted that refined routing graph 302 and reduced route search space 402, as well as the associated filtering, are provided as an example to help illustrate the technology, and that other filtering outcomes may occur based on the first set of routing constraints.

Referring back to FIG. 1, by filtering the refined routing graph, reduced route search space generator 122 provides the reduced route search space, which includes the remaining nodes and edges. In aspects, portions of the remaining route segments may be combined to form routes between the origin node and the destination node. These combinations can be explored by quantum annealer 108 when invoked by quantum annealer invoker 124. In doing so, quantum annealer invoker 124 determines the optimal route comprising a combination of two or more route segments between the origin node and the destination node.

Quantum annealer 108 may anneal the reduced route search space in accordance with an objective and second set of routing constraints. The second set of routing constraints may be one or more constraints. In aspects, the second set of constraints applied different constraints relative to the first set of routing constraints.

For example, the objective may minimize a duration of travel between the origin node and the destination node. In another aspect, the objective minimizes the distance of travel. Another example objective includes minimizing CO₂ output. In another aspect, delivery cost of traversing a route is minimized.

In some cases, route segments connecting nodes may be traversed by multiple vehicles. In some situations, vehicles will traverse the route segments at different times. For instance, one vehicle may leave before another. Thus, the vehicles traversing the route segment may have offset departure times and arrival times when traveling between a first node and a second node of the route segment. When employing an objective to minimize the duration of travel, quantum annealer 108 may select a vehicle traversing between the first and second node of the route segment based on the vehicle having an earlier departure or arrival time so as to reduce the overall duration of travel for the route that comprises the route segment.

In aspects, the second set of routing constraints comprises one or more of an origin node constraint that constrains the optimal route to the origin node, a destination node constraint that constrains the optimal route to the destination node, and a connected route segment constraint that constrains the optimal route to connected route segments.

To provide an example, let:
N: Number of routes traveled by vehicles, where vehicles may traverse multiple route segments;
n: number of nodes;
(k,i,j): route segments (i, j) of vehicle k where i, j ∈ n, i≠j, i being the origin and j being the destination;
d(p): initial origin (departure) node of vehicle transporting an item;
a(p): final destination (arrival) node of the vehicle transporting the item;
d_{i,j}^{k}: duration of travel for route segments (i, j) of vehicle k traveling multi-hop route; and
x_{i,j}^{k}: binary variable if d_{i,j}^{k}≠0 and i≠j.

Following the example, an objective function for minimizing the duration mean is provided as follows:

$${\sum }_{k = 0}^{N} {\sum }_{i , j = 0 , i \neq j}^{n} {d}_{i , j}^{k} {x}_{i , j}^{k} .$$

One or more example constraints may be provided as follows:
connected route segment constraint:

$${\sum }_{k = 0}^{N} {\sum }_{i , j = 0 , i \neq j}^{n} {x}_{i , j}^{k} ( {\sum }_{{k}^{′} = 0}^{N} {\sum }_{{i}^{′} , {j}^{′} = 0 , {i}^{′} = j}^{n} {x}_{{i}^{′} , {j}^{′}}^{{k}^{′}} ) = 1 ;$$

origin (departure) node constraint:

$${\sum }_{k = 0}^{N} {\sum }_{i , j = 0 , i = d ( p )}^{n} {x}_{i , j}^{k} = 1 ; and$$

destination (arrival) node constraint:

$${\sum }_{k = 0}^{N} {\sum }_{i , j = 0 , j = a ( p )}^{n} {x}_{i , j}^{k} = 1.$$

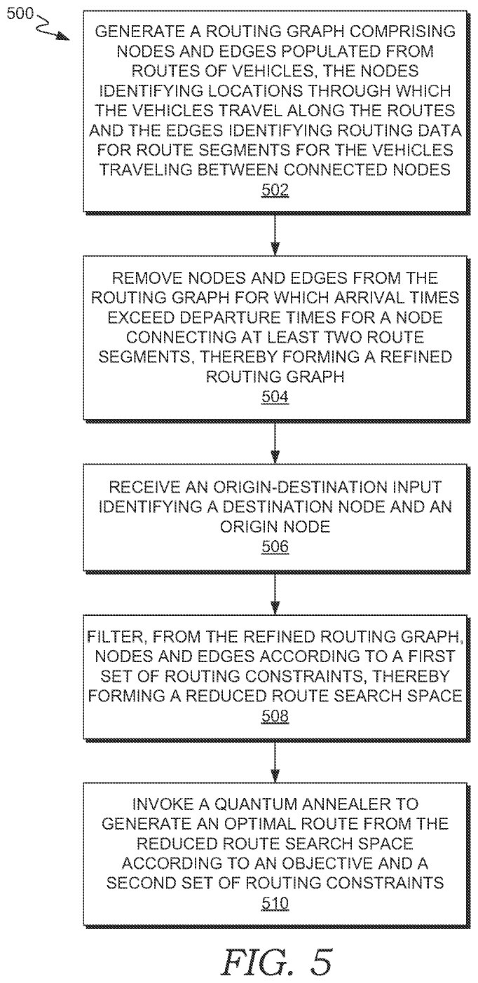

Turning now to FIG. 5, each block of method 500 may comprise a computing process performed using any combination of hardware, firmware, or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities. Method 500 may be implemented in whole or in part by components of operating environment 100, such as routing engine 112.

At block 502, method 500 generates a routing graph. This may be done using routing graph generator 118. The routing graph may comprise nodes and edges populated from routes of vehicles. The nodes may identify locations through which the vehicles travel along the routes, while the edges may identify routing data, such as routing data 114 and shipping data 116, for route segments for the vehicles traveling between connected nodes.

At block 504, method 500 forms a refined routing graph. This may be done using refined routing graph generator 120. Nodes and edges may be removed from the routing graph when generating the refined routing graph. For instance, nodes and edges for which arrival times exceed departure times for a node connecting at least two route segments may be removed. For example, for the edges (route segments) A-B and B-C, if the vehicle traversing B-C has a departure time is less than the arrival time of the vehicle traversing A-B, then the node B is removed from the refined routing graph.

At block 506, method 500 receives an origin-destination input identifying a destination node and an origin node. In aspects, the origin-destination input identifies an item to be transported from the origin node to the destination node. Shipping data associated with the item, such as volume, weight, and the like may be included or otherwise identified from the origin-destination input.

At block 508, method 500 forms a reduced route search space. This may be done using reduced route search space generator 122. In doing so, nodes and edges from the refined routing graph may be filtered according to a first set of routing constraints. As an example, the first set of routing constraints may include one or more of item delivery time, item weight, item volume, or the like. In an aspect, nodes and edges corresponding to route segments for routes that do not include at least one of the origin node and the destination node may be filtered.

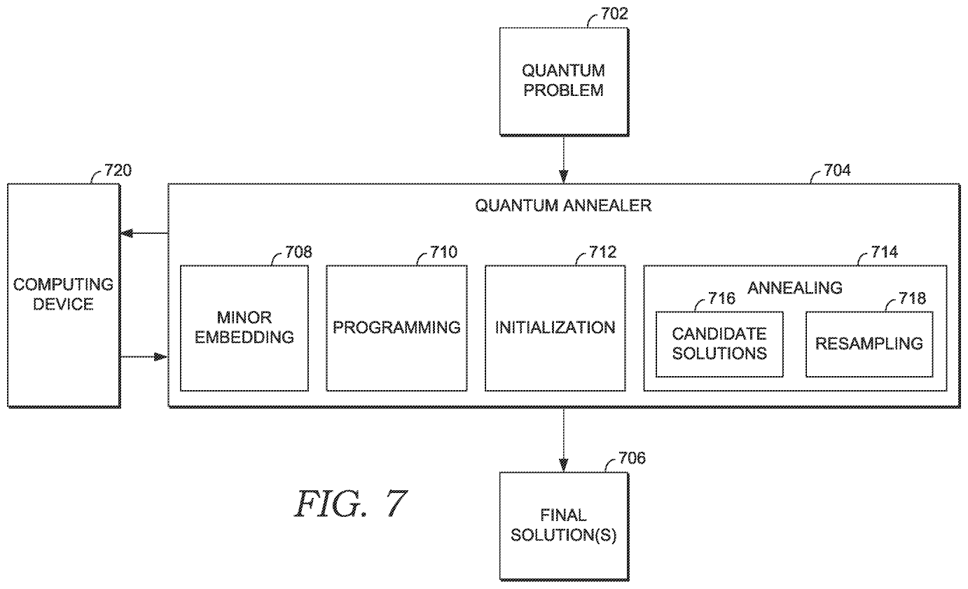

At block 510, method 500 invokes a quantum annealer to generate an optimal route from the reduced route search space. This may be done using quantum annealer invoker 124 invoking quantum annealer 108. The quantum annealer may anneal the reduced route search space according to an objective and a second set of routing constraints. The annealing process may correspond to that described with respect to FIG. 7. Thus, for instance, the objectives and constraints may be mapped and embedded to the quantum annealer. For instance, the objective and any one or more constraints translating may be translated into Quadratic Unconstrained Binary Optimization (QUBO) or Ising model function to be minimized by the quantum annealer. The problem may be mapped onto the physical layout of the quantum processor by assigning the problem's variables and their interactions (defined in the mapping process) to the qubits and their couplings. The problem now mapped to the quantum annealer, the problem may be initialized and solved to identify the energy state corresponding to the optimal route, as is further described below. The determined optional route includes nodes and edges consistent with the first set of objectives and constraints and the second set of objectives and constraints to that provides a solution that minimizes energy of the system.

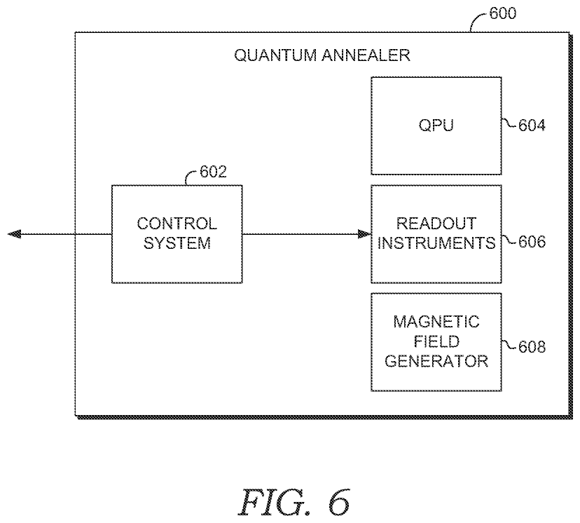

FIG. 6 illustrates an example quantum annealer 600 that may be employed with aspects of the technology. As FIG. 6 is only one example, other quantum annealers may be employed, some examples of which may include Quantum Systems annealers, employing superconducting qubits to find the optimal or near-optimal ground state solutions to solving proposed optimization problems. As such, other quantum annealers having more or fewer components, and having different arrangements or architectures, may be used. It is again noted that the illustrated quantum annealer 600 in FIG. 6 is only an example and is provided to aid in the description of the technology. It is not intended to limit the technology to one type of quantum annealer, or any type of quantum computing system. In the example provided, quantum annealer 600 comprises control system 602 operationally coupled to QPU (Quantum Processing Unit) 604, readout instruments 606, and magnetic field generator 608.

Control system 602 of quantum annealer 600 generally interfaces with components of quantum annealer 600, including QPU 604, readout instruments 606, and magnetic field generator 608, among other components not illustrated. For instance, control system 602 may operationally control or receive information from such components. Control system 602 facilitates quantum annealing functions, for example, translating a quantum problem into physical aspects of the QPU 604; setting parameters of the quantum annealing process, including the biases and couplings among qubits; managing the annealing schedule, a predefined protocol guiding the system from the initial to the final Hamiltonian that finds the global minimum representing the quantum problem's solution; among other functions and operations.

During the annealing process, the control system 602 generates and delivers signals to the qubits and couplers of QPU 604, manipulating their states and interactions in accordance with the quantum problem being executed. In aspects, as the annealing process concludes, control system 602 may oversee the readout of qubits' states in coordination with readout instruments 606, thus translating quantum information into classical data that can be interpreted by classical computing devices and algorithms.

Control system 602 may provide an interface for external systems by communicatively coupling with classical computing devices, such as computing device 1000 of FIG. 6, to facilitate the input of problem definitions and the output of solutions. Control system 602 itself may comprise a classical computer processor that reads from memory to execute computer-readable instructions stored thereon.

QPU 604 is the core of quantum computational activity. QPUs may house an array of qubits (quantum bits), which may exist in a superposition of states. QPU 604 facilitates quantum operations that exploit quantum phenomena like superposition and entanglement to solve quantum problems. Within QPU 604, couplers manage interactions between the qubits and form the basis for quantum logic gates and multi-qubit operations for quantum algorithms. Although not illustrated, QPU 604 may be cooled by a cooling de vice of quantum annealer 600 and shielded from other external components or interferences, helping to maintain quantum coherence.

QPU 604 may comprise control lines, across which signals are transmitted that guide quantum operations of QPU 604. QPU 604 may couple to readout instruments 606 that translate quantum states into classical data and communicate control system 602. Readout instruments 606 may include an analog-to-converter that translates the quantum state of the qubits to the digital space, thereby identifying the quantum state of the qubits in a manner readable by a classical machine, thus providing a candidate solution for the quantum problem to control system 602. In aspects, analog signals captured from qubit measurements may be amplified and filtered to sift through and eliminate noise.

Qubit states may be manipulated by control system 602 employing magnetic field generator 608. By varying the strength and orientation of the magnetic field, control system 602 can tailor the energy landscape that the qubits navigate during the annealing process. This magnetic field induces a bias on each qubit, influencing its tendency to take on a particular state during the annealing process.

The construction of quantum computers can be approached through various paradigms and hardware setups, among which gate-based quantum computing and adiabatic quantum computation (AQC) are predominant. Gate-based computing involves executing computations by applying a series of unitary gates to quantum bits (qubits), which are then measured at the computation's conclusion. Conversely, AQC starts with a many-qubit quantum state prepared as a simple Hamiltonian's ground state, which, through adiabatic time evolution, transitions to a final Hamiltonian, encoding the solution to a targeted optimization problem. AQC and gate-based quantum computing are polynomially equivalent since quantum circuits can be depicted as a time-dependent Hamiltonian with a maximal polynomial overhead.

Quantum annealing is closely related to AQC. Quantum annealing is a variant of the AQC model, employed when adiabatic conditions are unfulfilled, leading to a heuristic variational quantum algorithm. This technique is adept at identifying the ground state of Ising models, an NP (nondeterministic polynomial time)-hard challenge. NP-hard and NP-complete combinatorial optimization problems can be transformed to forms suitable for quantum annealers, either framed in Ising form or as a QUBO problem. For instance, these optimization problems can be transformed to Ising form using a {−1, 1} basis and spin variables or as a QUBO problem using the {0, 1} basis and binary variables. In quantum annealing, solving an optimization problem entails progressing through multiple stages, with the specifics of each stage being influenced by the kind of qubits utilized, the adiabatic protocol implemented, and other engineering factors.

FIG. 7 illustrates an example quantum annealing process 700 utilizing quantum annealer 704. FIG. 7 is only one example provided as an aid for understanding and using the technology described herein. At a high level, quantum annealer 704 receives an input, illustrated using example quantum problem 702, and outputs candidate final solution(s) 706. Quantum annealing process 700 illustrates processes 708-718 that may be performed by or for quantum annealer 704 to determine final solution(s) 706. For instance, some aspects may be performed by a classical computing device 720 communicatively coupled to quantum annealer 704. As an example, the classical computing device 720 may be used to facilitate minor-embedding process 708, programming process 710, and initialization process 712 in coordination with quantum annealer 704. Computing device 1000 is an example suitable for use as computing device 720. Computing device 720 may interface with a control system of quantum annealer 704, which may be the same or separate computing devices. As with other aspects of FIG. 7, each of the process is intended to represent an example, and nothing is intended to restrict the technology to a particular process or machine.

Having this in mind, quantum problem 702 may include optimization problems in various forms, such as a QUBO model and an Ising model. Real-world problems can be broken down into objectives and constraints. Optimization problems can be represented by the following QUBO form:

$$min ( {\sum }_{i} {a}_{i} {x}_{i} + {\sum }_{i} {\sum }_{j > i} {b}_{i , j} {x}_{i} {x}_{j} + c ) .$$

The binary variables xi and xj may take values from {0, 1}, and aᵢ, bᵢ, and c are constraints defined by the problem to be solved.

Optimization problems may be expressed by the Ising model, taking the following form:

$$min ( {\sum }_{i} \text{?} {s}_{i} + {\sum }_{i} {\sum }_{j > i} {J}_{i , j} {s}_{i} {s}_{j} ) .$$

$$\text{?} \text{indicates text missing or illegible when filed}$$

The binary variables sᵢ and sⱼ may take values from {-1, 1}, whereas J_{i,j} is the interaction of two adjacent sites <i,j> for a given magnetic field hi. The QUBO form and the Ising form may be translated from one another in some cases.

The models may be represented by a logical graph. For a QUBO problem, each node may correspond to a variable, which may correspond to qubits. Edges in this graph represent the interaction terms between pairs of variables and constraints, derived from the quadratic terms in the QUBO expression. Similarly, for an Ising model, each node may represent a spin and correspond to qubits. Edges may denote the interactions between pairs of spins (or variables) as dictated by the interaction terms in the Ising model's energy expression. Such models may be formulated or represented as a logical graph and provided as a quantum problem 702 to quantum annealer 704.

During minor-embedding process 708, the local graph of the initial quantum problem 702 may be translated onto the physical hardware of the quantum processing unit (QPU). Here, select sets of physical qubits represent the nodes, while couplings between the qubits correspond to the interaction of the logical variables.

During programming process 710, the quantum annealer 704 may be programmed with the parameters that define the problem. This problem may be the final Hamiltonian. The final Hamiltonian is a quantum mechanical operator that represents the problem to be solved in a form that quantum annealer 704 understands. It is derived from the logical representation of the problem (such as the QUBO formulation or the Ising model). The objective is to find the state (or configuration of qubits) that minimizes its energy, as this corresponds to the solution of quantum problem 702.

The programming process 710 may comprise setting weights for each qubit bias and coupler strength. Qubits in quantum annealer 704 can have a bias, for example, a term in the final Hamiltonian that represents an external magnetic field acting on the qubit. Setting the bias on a qubit influences its tendency to take a particular state (0 or 1). Weights for the qubit bias may be set based on the problem formulation to guide quantum annealer 704 toward the desired solution. Couplers may comprise elements in quantum annealer 704 that control the interaction between pairs of qubits. The strength of a coupler determines the extent to which the state of one qubit influences the state of another. Coupler strength may be set to represent the interactions between variables in quantum problem 702.

During initialization process 712, an initial Hamiltonian may be defined. The initial Hamiltonian may be constructed to have an achievable lowest energy (ground state) configuration. The design may serve as a starting point for the annealing process 714.

Through annealing process 714, quantum annealer 704 gradually transitions from the initial Hamiltonian to the final Hamiltonian (which was defined during the programming phase and represents the actual problem to be solved). Generally, as the system transitions, quantum annealer 704 attempts to maintain the lowest-energy configuration and ideally end in the ground state of the final Hamiltonian, which corresponds to the solution of the quantum problem 702. In some cases, annealing process 714 can also be combined with a reverse annealing phase, which initializes quantum annealer 704 with a known (classical) solution and searches the state space around this local optimum.

At the end of annealing process 714, quantum annealer 704 provides candidate solutions 716 to quantum problem 702. Here, the qubits in the QPU are in an eigenstate or a superposition of eigenstates with respect to the final Hamiltonian. An eigenstate refers to a state with a well-defined energy and represents a possible solution. A superposition of eigenstates refers to multiple eigenstates at once, each representing a potential solution to the problem. Each qubit's spin (either up or down) is read out, and the collection of spin values represents a candidate solution to quantum problem 702.

Quantum annealing is heuristic and the exact optimal solution (ground state of the final Hamiltonian) may not be found in every run. Instead, the candidate solutions 716 provide a good enough solution in a reasonable amount of time. Naturally, there's a non-zero probability of ending up in a non-optimal solution due to various quantum phenomena like tunneling and thermal fluctuations. As such, annealing process 714 may undergo resampling 718, which repeats the annealing process 714 in an effort to identify a better solution than prior candidate solutions 716. Each resampling process provides a new opportunity for the quantum annealer 704 to explore the solution space and possibly find a better or different candidate solution. Resampling 718 may be performed as many times as desired, as time and continued benefit allow. By comparing candidate solutions 716, the best candidate solution or even a variety of candidate solutions may be chosen as solutions to quantum problem 702 and output as final solution(s) 706.

Having described an overview of some embodiments of the present technology, an example computing environment in which embodiments of the present technology may be implemented is described below in order to provide a general context for various aspects of the present technology. Referring now to FIG. 8 in particular, an example operating environment for implementing embodiments of the present technology is shown and designated generally as computing device 800. Computing device 800 is but one example of a suitable computing environment and is not intended to suggest any limitation as to the scope of use or functionality of the technology. Computing device 800 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 802, which directly or indirectly couples the following devices: memory 804, one or more processors 806, one or more presentation components 808, input/output (I/O) ports 810, input/output components 812, and illustrative power supply 814. Bus 1002 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 8 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 8 and with reference to “computing device.”

Computing device 800 typically includes a variety of computer-readable media. Computer-readable media can be any available media that can be accessed by computing device 800 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 800. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 804 includes computer storage media in the form of volatile or non-volatile memory. The memory may be removable, non-removable, or a combination thereof. Example hardware devices include solid-state memory, hard drives, optical-disc drives, etc. Computing device 800 includes one or more processors that read data from various entities, such as memory 804 or I/O components 812. Presentation component(s) 808 presents data indications to a user or other device. Example presentation components include a display device, speaker, printing component, vibrating component, etc.

I/O ports 810 allow computing device 800 to be logically coupled to other devices, including I/O components 812, some of which may be built-in. Illustrative components include a microphone, joystick, game pad, satellite dish, scanner, printer, wireless device, etc. The I/O components 812 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 800. Computing device 800 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 800 may be equipped with accelerometers or gyroscopes that enable detection of motion. The output of the accelerometers or gyroscopes may be provided to the display of computing device 800 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, functional components of FIG. 1 can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of routing engine 112, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “computing device” is intended to refer to a classical computing device, such as computing device 800 of FIG. 8. Other related terms, including “client device,” “server,” and the like are similarly intended to refer to a classical computing device. Terms that include “quantum” are intended to refer to a quantum computing device, such as a quantum annealer. An example quantum computing device is illustrated and described with respect to FIG. 6.

An optimal solution (also referred to as optimal route) as described herein is intended to be the most favorable solution derived from a set of potential solutions generated within the constraints of available processing power and time. This solution minimizes or maximizes the defined objective(s) based on the data and algorithms employed during the computational process, such as the annealing process. It represents the best solution among those explored, within the computational resources allocated, to solve the optimization problem and achieve the desired logistical outcome. While it may not represent the absolute best solution possible due to limitations in computational resources, data accuracy, or physical interferences, it stands as the most efficient or effective solution identified through the computational process undertaken for a given set of parameters.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example embodiment that may be practiced for the description include, but are not limited to, the following:
Aspect 1: A computerized method comprising: generating a routing graph comprising nodes and edges populated from routes of vehicles, the nodes identifying locations through which the vehicles travel along the routes and the edges identifying routing data for route segments for the vehicles traveling between connected nodes; removing nodes and edges from the routing graph for which arrival times exceed departure times for a node connecting at least two route segments, thereby forming a refined routing graph; receiving an origin-destination input identifying a destination node and an origin node; filtering, from the refined routing graph, nodes and edges according to a first set of routing constraints, thereby forming a reduced route search space; and invoking a quantum annealer to generate an optimal route from the reduced route search space according to an objective and a second set of routing constraints.
Aspect 2: A system comprising: a quantum annealer; at least one processor; and one or more computer storage media storing computer-readable instructions thereon that when executed by the at least one processor cause the at least one processor to perform operations comprising: generating a routing graph comprising nodes and edges populated from routes of vehicles, the nodes identifying locations through which the vehicles travel along the routes and the edges identifying routing data for route segments for the vehicles traveling between connected nodes; removing nodes and edges from the routing graph for which arrival times exceed departure times for a node connecting at least two route segments, thereby forming a refined routing graph; receiving an origin-destination input identifying a destination node and an origin node; filtering, from the refined routing graph, nodes and edges according to a first set of routing constraints, thereby forming a reduced route search space; and invoking the quantum annealer to generate an optimal route from the reduced route search space according to an objective and a second set of routing constraints.
Aspect 3: One or more computer storage media storing computer-readable instructions thereon that, when executed by a processor, cause the processor to perform operations comprising: removing nodes and edges from a routing graph, the routing graph comprising nodes and edges populated from routes of vehicles, the nodes identifying locations through which the vehicles travel along the routes and the edges identifying routing data for route segments for the vehicles traveling between connected nodes, the nodes and edges removed based on arrival times exceeding departure times for a node connecting at least two route segments, thereby forming a refined routing graph; receiving an origin-destination input identifying a destination node and an origin node; filtering, from the refined routing graph, nodes and edges according to a first set of routing constraints, thereby forming a reduced route search space; and invoking a quantum annealer to generate an optimal route from the reduced route search space according to an objective and a second set of routing constraints.
Aspect 4: Any of Aspects 1-3, wherein the reduced route search space is formed by further filtering routes that exclude at least one of the destination node and the origin node.
Aspect 5: Any of Aspects 1-4, wherein the origin-destination input corresponds to an item delivery, the item delivery having an associated item delivery time by which to deliver the item, and wherein the first set of routing constraints includes the associated item delivery time such that the reduced route search space is formed by filtering routes that have arrival times at the destination node that are beyond the item delivery time.
Aspect 6: Any of Aspects 1-5, wherein the first set of routing constraints includes a weight of an item such that the reduced route search space is formed by filtering routes by vehicles for which the weight of the item exceeds a vehicle weight capacity.
Aspect 7: Any of Aspects 1-6, wherein the first set of routing constraints includes a volume of an item such that the reduced route search space is formed by filtering routes by vehicles for which the volume of the item exceeds a vehicle volume capacity.
Aspect 8: Any of Aspects 1-7, wherein the objective minimizes duration and the second set of routing constraints constrains the objective to the destination node and the origin node and constrains the objective to connected route segments.
Aspect 9: Any of Aspects 1-8, wherein the reduced route search space comprises a route segment having a plurality of offset departure and arrival times for vehicles traveling between a first node and a second node of the route segment, and wherein the quantum annealer selects a vehicle having a departure and arrival time from the plurality of offset departure and arrival times for inclusion in the optimal route.

What is claimed is:

1. A computerized method comprising:
generating a routing graph comprising nodes and edges populated from routes of vehicles, the nodes identifying locations through which the vehicles travel along the routes and the edges identifying routing data for route segments for the vehicles traveling between connected nodes;
removing nodes and edges from the routing graph for which arrival times exceed departure times for a node connecting at least two route segments, thereby forming a refined routing graph;
receiving an origin-destination input identifying a destination node and an origin node;
filtering, from the refined routing graph, nodes and edges according to a first set of routing constraints, thereby forming a reduced route search space; and
invoking a quantum annealer to generate an optimal route from the reduced route search space according to an objective and a second set of routing constraints.

2. The method of claim 1, wherein the reduced route search space is formed by further filtering routes that exclude at least one of the destination node and the origin node.

3. The method of claim 1, wherein the origin-destination input corresponds to an item delivery, the item delivery having an associated item delivery time by which to deliver the item, and wherein the first set of routing constraints includes the associated item delivery time such that the reduced route search space is formed by filtering routes that have arrival times at the destination node that are beyond the item delivery time.

4. The method of claim 1, wherein the first set of routing constraints includes a weight of an item such that the reduced route search space is formed by filtering routes by vehicles for which the weight of the item exceeds a vehicle weight capacity.

5. The method of claim 1, wherein the first set of routing constraints includes a volume of an item such that the reduced route search space is formed by filtering routes by vehicles for which the volume of the item exceeds a vehicle volume capacity.

6. The method of claim 1, wherein the objective minimizes duration, and
the second set of routing constraints constrains the objective to the destination node and the origin node and constrains the objective to connected route segments.

7. The method of claim 1, wherein the reduced route search space comprises a route segment having a plurality of offset departure and arrival times for vehicles traveling between a first node and a second node of the route segment, and wherein the quantum annealer selects a vehicle having a departure and arrival time from the plurality of offset departure and arrival times for inclusion in the optimal route.

8. A system comprising:
a quantum annealer;
at least one processor; and
one or more computer storage media storing computer-readable instructions thereon that when executed by the at least one processor cause the at least one processor to perform operations comprising:
generating a routing graph comprising nodes and edges populated from routes of vehicles, the nodes identifying locations through which the vehicles travel along the routes and the edges identifying routing data for route segments for the vehicles traveling between connected nodes;
removing nodes and edges from the routing graph for which arrival times exceed departure times for a node connecting at least two route segments, thereby forming a refined routing graph;
receiving an origin-destination input identifying a destination node and an origin node;
filtering, from the refined routing graph, nodes and edges according to a first set of routing constraints, thereby forming a reduced route search space; and
invoking the quantum annealer to generate an optimal route from the reduced route search space according to an objective and a second set of routing constraints.

9. The system of claim 8, wherein the reduced route search space is formed by further filtering routes that exclude at least one of the destination node and the origin node.

10. The system of claim 8, wherein the origin-destination input corresponds to an item delivery, the item delivery having an associated item delivery time by which to deliver the item, and wherein the first set of routing constraints includes the associated item delivery time such that the reduced route search space is formed by filtering routes that have arrival times at the destination node that are beyond the item delivery time.

11. The system of claim 8, wherein the first set of routing constraints includes a weight of an item such that the reduced route search space is formed by filtering routes by vehicles for which the weight of the item exceeds a vehicle weight capacity.

12. The system of claim 8, wherein the first set of routing constraints includes a volume of an item such that the reduced route search space is formed by filtering routes by vehicles for which the volume of the item exceeds a vehicle volume capacity.

13. The system of claim 8, wherein the objective minimizes duration, and the second set of routing constraints constrains the objective to the destination node and the origin node and constrains the objective to connected route segments.

14. The system of claim 8, wherein the reduced route search space comprises a route segment having a plurality of offset departure and arrival times for vehicles traveling between a first node and a second node of the route segment, and wherein the quantum annealer selects a vehicle having a departure and arrival time from the plurality of offset departure and arrival times for inclusion in the optimal route.

15. One or more computer storage media storing computer-readable instructions thereon that, when executed by a processor, cause the processor to perform operations comprising:
removing nodes and edges from a routing graph, the routing graph comprising nodes and edges populated from routes of vehicles, the nodes identifying locations through which the vehicles travel along the routes and the edges identifying routing data for route segments for the vehicles traveling between connected nodes, the nodes and edges removed based on arrival times exceeding departure times for a node connecting at least two route segments, thereby forming a refined routing graph;
receiving an origin-destination input identifying a destination node and an origin node;
filtering, from the refined routing graph, nodes and edges according to a first set of routing constraints, thereby forming a reduced route search space; and
invoking a quantum annealer to generate an optimal route from the reduced route search space according to an objective and a second set of routing constraints.

16. The media of claim 15, wherein the reduced route search space is formed by further filtering routes that exclude at least one of the destination node and the origin node.

17. The media of claim 15, wherein the origin-destination input corresponds to an item delivery, the item delivery having an associated item delivery time by which to deliver the item, and wherein the first set of routing constraints includes the associated item delivery time such that the reduced route search space is formed by filtering routes that have arrival times at the destination node that are beyond the item delivery time.

18. The media of claim 15, wherein the first set of routing constraints includes a weight of an item such that the reduced route search space is formed by filtering routes by vehicles for which the weight of the item exceeds a vehicle weight capacity.

19. The media of claim 15, wherein the first set of routing constraints includes a volume of an item such that the reduced route search space is formed by filtering routes by vehicles for which the volume of the item exceeds a vehicle volume capacity.

20. The media of claim 15, wherein the objective minimizes duration, and the second set of routing constraints constrains the objective to the destination node and the origin node and constrains the objective to connected route segments.
